(19) United States
(12) Patent Application Publication
(10) Pub. No.: US 2014/0129307 A1
(43) Pub. Date: May 8, 2014

(54) System and Method for Facilitating Commercial Interactions via a Physical Insignia

(71) Applicant: ProductTap, LLC, Hingham, MA (US)

(72) Inventors: John Michael Walker, Hingham, MA (US); Peter John Shea, Scituate, MA (US); Wilson Law Learned Kerr, Brookline, MA (US)

(73) Assignee: ProductTap, LLC, Hingham, MA (US)

(21) Appl. No.: 14/067,281

(22) Filed: Oct. 30, 2013

Related U.S. Application Data
(60) Provisional application No. 61/722,119, filed on Nov. 2, 2012.

(51) Int. Cl. G06Q 30/02

(52) U.S. Cl. CPC G06Q 30/0222
USPC 705/14.16; 705/14.23

(57) ABSTRACT

According to aspects of the present invention, a system, method, and device utilizes insignia such as electronic near field communication (e.g., NFC or RFID) tags or preprogrammed visual insignia (e.g., QR code or bar code) attached to or associated with physical products or service offerings and linked to an Internet-based user interface with a supporting database. In different embodiments, the present invention includes: a registration management component; an offer management component; a loyalty program management component, a referral management component; a purchase and service management component; a customer feedback component; and an interaction tracking component.

### FIELD OF THE INVENTION

The present invention relates to mobile communications, and more particularly to facilitating commerce through tracking user mobile communications activity vis-à-vis physical insignias associated with commercial offerings.

### BACKGROUND

Mobile communications devices are ubiquitous. Further, near field communication (“NFC”) or, more broadly, radio frequency identification (“RFID”) and barcode technologies are known to provide methods for obtaining or tracking information about products and/or providing information or calls to action to a user or device that invokes (e.g., scans or taps) representations of barcodes and electronic NFC/RFID tags for the purpose of accessing such information or calls to action.

### SUMMARY

According to aspects of the present invention, a system, method, and device utilizes insignia that contain embedded NFC/RFID tags or that display preprogrammed visual insignia (e.g., QR code or bar code) attached to or associated with physical products or service offerings and linked to an Internet-based user interface with a supporting database. In different embodiments, the present invention includes: a registration management component; an offer management component; a loyalty program management component, a referral management component; a purchase and service management component; a customer feedback component; and an interaction tracking component.

Aspects of the present invention utilize computing devices, such as mobile computing devices, scannable insignia or NFC/RFID tag technology, Internet-based user interfaces and/or a downloadable application, and a database to provide manufacturers, distributors and/or sellers of products and services (i.e., sales-side entities) a channel for interacting with product owners and other individuals (i.e., consumer-side entities) who encounter their commercial product or service offerings. In various aspects, the present invention provides a system having several components, including: a registration management component, an offer management component, a loyalty program management component, a referral management component, a purchase and service management component, a customer feedback component and an interaction tracking component.

### BRIEF DESCRIPTION OF THE DRAWINGS

FIG. 1 shows a schematic diagram illustrating one embodiment of the system of the present invention.

FIG. 2 is a flow diagram illustrating various actions and actors associated with and implementing aspects of the present invention.

### DETAILED DESCRIPTION OF EMBODIMENTS OF THE PRESENT INVENTION

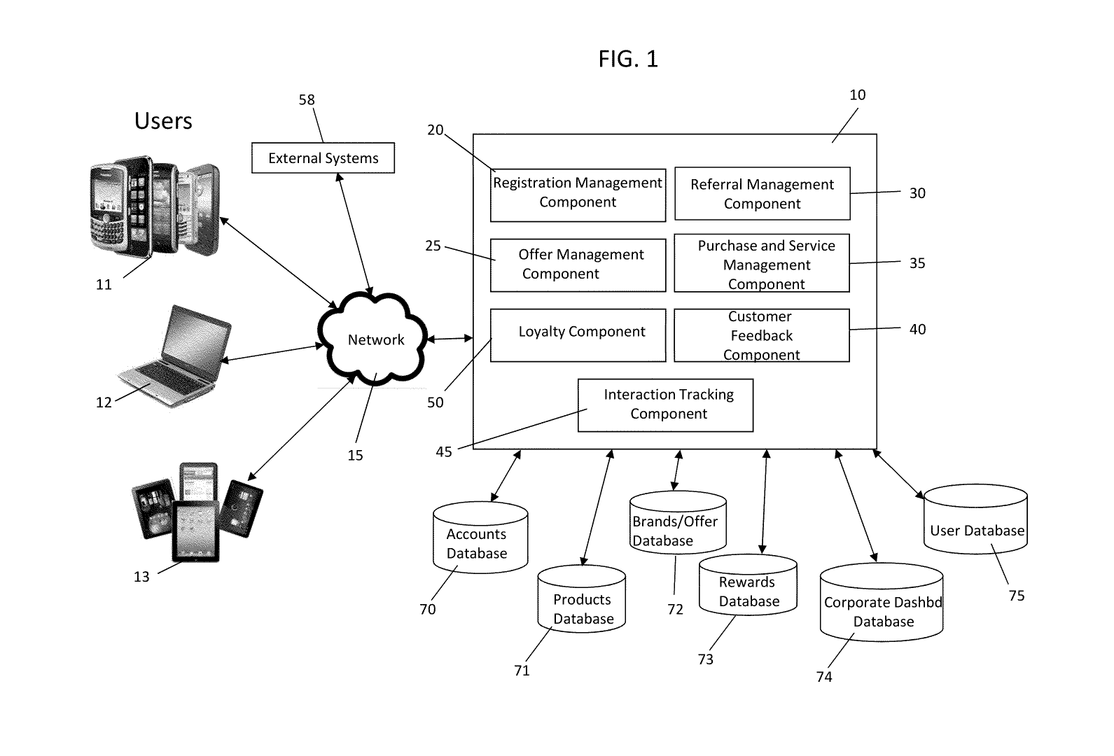

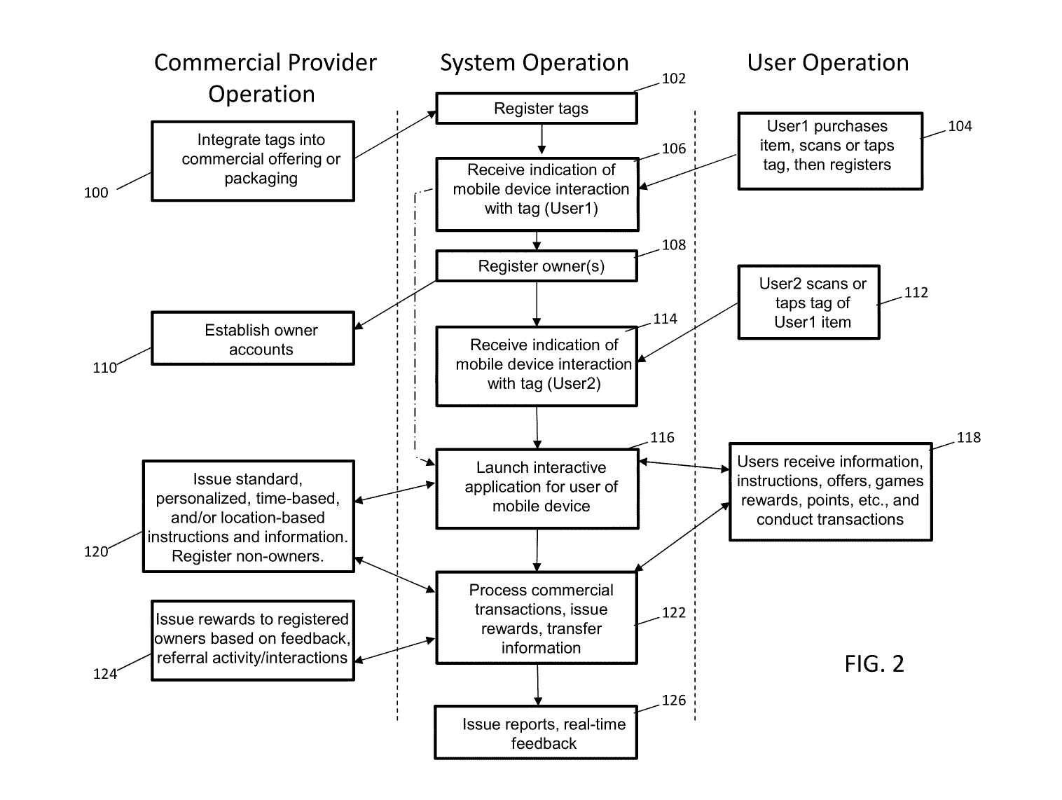

As shown in FIGS. 1 and 2, the present invention provides, in part, a system 10 having various components that facilitate commercial interactions using physical insignia. Various users of the present invention can access and implement functions provided by the system 10 using devices, such as mobile communications devices 11, laptop and other similar computing devices 12 and tablet computing devices 13, for example. While such devices 11, 12 and 13 are shown in FIG. 1, it will be appreciated that desktop computers and other computing devices not shown could potentially be employed with the present invention, although the present invention may be better suited to smaller form factor mobile computing devices that may be more readily available to users in the ordinary course of their social and commercial interactions.

The users can employ devices to access and implement functions provided by the system of the present invention using network 15, which can be a public network such as the Internet, for example, or a non-public network.

In various aspects, the system of the present invention includes a registration management component 20, an offer management component 25, a loyalty program management component 50, a referral management component 30, a purchase and service management component 35, a customer feedback component 40, and an interaction tracking component 45. The present invention can further include a loyalty component 50. It will be appreciated that the components described need not be physically or electronically partitioned as standalone components. For example, all components can be provided as part of a single computer software program.

The registration management component 20 can include software for registering an individual or entity as owner of a commercial offering. It will be appreciated that the use of the term “offering” or “product” herein need not be considered as limited to a physical product, but can include a service or other commercial offering available to a consuming party. For example, physical insignia such as tags, codes or other physical insignia placed on a product or on an accompanying wallet card or sticker can initiate the opening of an Internet page (which can be mobile-optimized) on a user's mobile device when tapped or scanned using the device. In one embodiment of the present invention, the Internet page can present content to the user that can be customized and modified by the brand, product manufacturer, or seller of the product. The form by which the insignia is numbered, configured, or programmed determines the content presented to users when the insignia is tapped/scanned with a mobile device, in accordance with operational embodiments of the present invention. Once the user has tapped/scanned the insignia, the user can register as an owner of the commercial offering through the registration management component 20 by providing identifying information on the Internet page, or by logging into a personal account, for example. The user may also register product warranties through the registration management component 20. In various embodiments of the present invention, the present invention can present users with ways to create or log into an account using their credentials from established web sites such as Facebook, Twitter, Google, Amazon, etc. Alternatively, users may register themselves as product owners (without first tapping/scanning the insignia) via an Internet page or an application associated with the present invention. Users may also be presented with the option to download an application associated with the present invention for their mobile device. It will be appreciated that such an application can contain the same functionality described herein. In these ways, the owner can be associated with the product, and this association is stored in a database provided as part of the system of the present invention. In one embodiment of the present invention, data storage can be provided as a single database, or can be managed with multiple specialized databases as shown in FIG. 1, including an accounts database 70, a products database 71, a brands/offer database 72, a rewards database 73, a corporate dashboard database 74 and a user database 75, for example. The user database 75 can store information about individual consumer users as well as corporate users, such as brand owners, product manufacturers, distributors and others. The accounts database 70 can store information about established individual consumer and commercial accounts, including transaction history, loyalty rewards and other account information, for example. The association may also be stored on the mobile device itself, by internet browser cookies, by application, or by similar computer code, for example.

The offer management component 25 of the present invention can include software for presenting special commercial offers to any individual who interacts with the product, including but not limited to the registered owner of the product. Further to the description above, the Internet page (or, alternatively, the device-based software application) associated with the present invention can facilitate the presentation of sales and other commercial offers to anyone who scans or taps a product's insignia. In this way, it will be appreciated that the present invention provides the ability, by the brand, product manufacturer and/or seller of the product, to control and customize the messaging that is delivered to the mobile device of the individual who scans or taps a product's insignia. Such messaging can be controlled, for example, via an online administrative control panel or dashboard associated with the present invention. Offers may include, but are not limited to, a chance to immediately purchase the product that was tapped/scanned, a chance to buy the product at a discount, limited time offers, and other special sales offers. Offers to purchase product accessories, complementary products, services, and other products or services that might be of interest may also be presented in accordance with aspects of the present invention. Additional offers may include, but are not limited to, access to detailed product information, user's/owner's manuals, product ratings and reviews, product usage tips, FAQs, product warrantee information, photos, videos, how-to instructions, how and where to purchase, and other product-related content. The above information can be obtained via products database 71 and brands/offer database 72 in accordance with embodiments of the present invention. Brands, product manufacturers, and retailers may vary offers depending on the product tapped/scanned, the characteristics and/or demographics of the user, the geographic location of the user, or even the identity of individual users.

The referral management component 30 of the present invention can include software for tracking, facilitating, and rewarding the product owner for commercial transaction (e.g., sales) referrals. When a user taps or scans a product's insignia, the event is recorded in a database, along with information that identifies the device and/or owner, as well as the user who tapped or scanned the product, if identifiable (for example, if they are another user of the present invention). The product tap/scan event may also be recorded by software code on the mobile device itself by Internet browser cookies, by an application, or by similar computer code associated with the present invention, for example. If a specific product already has a registered owner, subsequent taps or scans of its insignia may pull up new content specifically intended for referral customers. In this case, taps or scans of the insignia may result in the display of additional product information and/or special offers as described above. If referral customers ultimately make a purchase, they may tap or scan the insignia on their newly purchased product to establish themselves as the product owner, or if they are users of the invention, this association will be made automatically when they purchase. When they do so, the database can recognize and associate the new owner with the previously tapped/scanned registered product. Consequently, it becomes possible to identify products and owners who may have influenced subsequent purchases made days, weeks, or even months later. The referral management component 30 of the present invention can present a wide range of rewards to motivate product owners to act as sales ambassadors for the products they own, as illustrated in FIG. 2, for example. These rewards can be presented on mobile-optimized web pages or via a mobile device software application, for example, and can be controlled via the online administrative control panel or dashboard, in various embodiments of the present invention. Reward offers may also be “pushed” to product owners via text message, email, or other communication channels in accordance with the present invention. It will be appreciated that the referral management component 30 can interact with a separate loyalty component 50, wherein the loyalty component 50 can access specific rewards from a rewards database 73 associated with the present invention, and interact with external systems 58 via network 15 to provide reward feedback, obtain new reward offers, and otherwise assist in managing the referrals and rewards via referral management component 30. In one embodiment, the loyalty component 50 and the referral management component 30 may interact with external loyalty programs 58 (via network 15) that are offered by the brand, product manufacturer, or seller of the product. The present invention can further track and update reward accounts in an associated accounts database 70, for example.

The purchase and service management component 35 of the present invention can include software for presenting the product owner with product information, purchasing options, access to customer service, and other product-related services. As previously described, insignias such as tags placed on the product or on an accompanying wallet card or sticker can initiate the opening of an Internet page or an application when tapped or scanned using a computing device. This Internet page or application may display links to product details such as product descriptions and specifications, accessories, user's/owner's manuals, product ratings and reviews, product usage tips, FAQs, product warranty information, photos, videos, how-to instructions, how and where to purchase, and other product-related content. The presentation of this data may be programmatically generated based on input from the manufacturer or reseller, or by custom business logic inherent to the invention. Such information can be stored in database 71, and/or obtained from external systems 58. In one embodiment of the present invention, the Internet page or application will provide users with the ability to purchase the product and accessories immediately, directly from their mobile device. The purchase and service management component 35 may process the purchase itself, or it may interact with an external purchasing system 58 operated by the brand, product manufacturer, seller of the product, or a third party e-commerce services provider for transaction processing. The Internet page or application may also display links, phone numbers, or other ways to directly contact customer service for the tagged product and for other product-related service offerings directly.

The customer feedback component 40 of the present invention can include software for sharing, soliciting and recording customer feedback about the product. As previously described, insignia (e.g., tags) placed on the product or on an accompanying wallet card or sticker open up an Internet page (which can be mobile-optimized in various embodiments) or an application on a user's computing device when tapped or scanned using the device. This web page or application may display links as prompted in accordance with the present invention, wherein the links can enable the user to share information about the product via established social media platforms including but not necessarily limited to Facebook, Google+, Pinterest, and Twitter. The web page or application may also display links for sharing product information via email, text message, a scannable QR code displayed on a mobile device's screen, or NFC/RFID communications technology. The web page or application can also present various ways for users to share product feedback and related information with brand owners, product manufacturers, or sellers. For example, users may provide feedback by answering survey questions, uploading photos or videos, and/or sharing tips. All feedback can be stored in a database (e.g., 70, 71, 72, 75) associated with the present invention for future reference. In such ways, the present invention provides the ability, by a brand owner, product manufacturer and/or seller of a product, to control and customize what information is delivered to the computing device of the individual who scans or taps a product's insignia. As such, the online administrative control panel or dashboard associated with the present invention can offer the brand owner, product manufacturer and/or seller survey-building tools and other means for soliciting product-related feedback from product owners. In one embodiment of the present invention, a corporate dashboard database 74 is provided to assist the commercial provider (e.g., brand owner, product manufacturer, seller) with managing information pertaining to what is offered to users, what is obtained from users, success metrics and other valuable business information.

The interaction tracking component 45 of the present invention can include software for tracking interactions between any individual, including but not limited to the registered owner of the product, and the product's tag. The present invention allows brand managers, product manufacturers and/or sellers to gain insights into the peer to peer interactions that arise from products. These insights are possible because all interactions between individual mobile devices and product tags can be logged and stored in a database (e.g., 70, 74, 75) associated with the present invention. Logged events can include but are not limited to: the date and time the insignia is tapped/scanned; the geographic location of the insignia that is tapped/scanned, if available; the product associated with the insignia that is tapped/scanned; the owner (if any) associated with the insignia that is tapped/scanned; any sharing of product information or commercial or social offers, and the channel (e.g., established social media platforms, text message, email) by which it is shared; all user activity (e.g., selections, purchases, service, etc.) on the associated web page or application. It will be appreciated that data stored in the database associated with the present invention can be aggregated for reporting and/or resale purposes.

As described above, it will be appreciated that the components of the present invention as described above may be adapted to both physical products and to service offerings. For example, service providers can provide their customers and/or prospects with tagged business cards. Those customers (or prospects) can register themselves as service offering “owners” and utilize the other components described above, just as a product owner would.

FIG. 2 illustrates operational flows in accordance with various embodiments of the present invention, and further in accordance with various actors using the present invention. For instance, there is activity by: (1) a commercial provider, such as a brand owner, sales agent or manufacturer, for example; (2) the system of the present invention; and (3) a user such as an individual consumer, for example.

As shown at step 100 in FIG. 2, a commercial provider integrates insignia such as tags into their commercial offering or packaging. This can be an NFC/RFID tag or a QR code, for example, placed and/or secured to a physical product, a label, a tag or packaging associated with a physical product. Alternatively, this can be an insignia incorporated into visual programming on a screen or interface (e.g., of a kiosk, television or other electronic device capable of providing a visual display that can be scanned or tapped with a suitable computing device in accordance with the present invention). Further, this step can involve an insignia placed on an advertisement or other physical form, advertising services that may be offered by the commercial provider. At step 102, the present invention registers the insignia/tags, and the registration process can be actively performed by a commercial provider (e.g., an agent for a commercial provider registers the tags through registration management component 20 or another component (not shown) for letting the system of the present invention know what products have been tagged). Alternatively, the product/tag registration process can be performed for the commercial provider in advance, such as by pre-registering tags for one or more products, storing the product/tag association, and issuing the tags to the commercial provider for incorporating into the product. Note that the product tags may identify both the product type (brand, model number, size, color and other attributes) as well as the individual, specific, unique product by accessing and leveraging unique product serial numbers or similar unique identifiers for this identification and subsequent use. The product/tag association information and preprogrammed related/triggered actions can be stored in products database 71, for example.

At step 104, a first user can purchase an item with an insignia, or scan or tap an insignia without purchasing the item. The scanning or tapping of the insignia integrated with the product can be considered “invoking” the insignia for purposes of the present disclosure. Whether the user purchases the product with the insignia or not, at step 106, the present invention senses that the product insignia has been scanned or tapped, and presents information on the user's computing device for further interaction as exemplified above. In the event the user has purchased the product and wishes to register using the system of the present invention as part of step 102, the present invention can register the user at step 108, and record the user's registration in a database as exemplified in FIG. 1. It will be appreciated that registration is not required by the present invention, or for the present invention to work. Product owner accounts can be established as part of step 108 via system 10 and database 70, for example, and may further or separately be established with the commercial provider at step 110, as the commercial provider may wish to engage in their own commercial or promotional communications with the product owner, including warranty registration and loyalty program-related communications, for example.

At step 112, a second user can scan or tap the same insignia on the first user's product using the second user's computing device. The system of the present invention then senses the interaction at step 114, and initiates the application or web page at step 116 for displaying appropriate information as described above on the second user's device. At step 118, the users can receive information, instructions, offers, games, rewards, points, etc., and can thereby or thereafter conduct transactions via the present invention. In one embodiment of the present invention, the system receives the second user's interaction (e.g., tapping or scanning the insignia on the first user's product) and, as part of step 118, provides notification to the first user on the first user's device of the second user's interaction. The notification can take various forms, including notification of rewards, notification of complementary product offers, a thank you for the sales referral, and other communications. Depending upon the level of interaction or pre-established rules set up by one or more commercial providers, at step 120, the commercial provider may initiate (or may have pre-established a rule to automatically initiate via system of the present invention) the issuance of instructions and/or information, including, for example, standard, personalized, time-based, and/or location-based instructions and information. The commercial provider may further desire to register non-owners either on its own system or via system 10 of the present invention.

At step 122, the system of the present invention can process any transactions that may be set to occur or that may transpire as a result of the user action and/or information presented to the users. For example, the system can process a purchase transaction by the second user, process rewards to the first user for the second user's interaction (whether a purchase or simply a scan or tap of the tag). At step 124, the commercial provider can issue rewards to registered users as desired based upon feedback, referred interactions, or whatever behavior the commercial provider elects to reward. At step 126, the system of the present invention can further issue reports, provide real-time feedback and otherwise control and process communications to the commercial provider(s) and users.

Unless otherwise stated, devices, systems or components of the present invention that are in communication with each other do not need to be in continuous communication with each other; events and activities can be recorded asynchronously. Further, devices, systems or components in communication with other devices, systems or components can communicate directly or indirectly through one or more intermediate devices, components or other intermediaries. Further, descriptions of embodiments of the present invention herein wherein several devices, systems and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, NFC, RFID, GSM, CDMA, EDGE and EVDO.

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

The present disclosure describes numerous embodiments of the present invention, and these embodiments are presented for illustrative purposes only. These embodiments are described in sufficient detail to enable those skilled in the art to practice the invention, and it will be appreciated that other embodiments may be employed and that structural, logical, software, electrical and other changes may be made without departing from the scope or spirit of the present invention.

Accordingly, those skilled in the art will recognize that the present invention may be practiced with various modifications and alterations. Although particular features of the present invention can be described with reference to one or more particular embodiments or figures that form a part of the present disclosure, and in which are shown, by way of illustration, specific embodiments of the invention, it will be appreciated that such features are not limited to usage in the one or more particular embodiments or figures with reference to which they are described. The present disclosure is thus neither a literal description of all embodiments of the invention nor a listing of features of the invention that must be present in all embodiments. In one embodiment of the operation of the present invention, a product manufacturer or seller would subscribe to use the invention and would then attach the NFC/RFID tags or scannable insignia to the products they manufacture or sell. The tags will be pre-programmed with enough information to identify the product and, where possible, the product's serial number. Once the product is purchased, the owner can use their mobile device to scan the insignia or tap the NFC/RFID tag and register themselves as the owner of the product. This information is stored in a database and accessed by means of a secure online administrative dashboard. This associates the product with the owner and the owner is provided with instructions about how to convey information about the product to other individuals they may come into contact with who may be interested in this product.

Once the product is registered the invention then uses the unique NFC/RFID tag or scannable insignia to trigger the conveyance of specific product information and calls to action that are controlled by the product manufacturer or seller via the administrative dashboard. The consumer who scans the insignia or taps the NFC/RFID tag is given information allowing them to purchase the product or watch a video or obtain product detail information or access other predetermined information, as delivered by the invention. These interactions are tracked by the invention and displayed in the online administrative dashboard and used to trigger certain rewards and incentives that are delivered to the product owner in exchange for the role they played in the interaction between the product and the individual who scanned the insignia based on their interaction with that individual. All mobile device interactions between the scanned NFC/RFID tag or insignia attached to the product and the purchaser of the product are stored and tracked in the invention, along with the interactions between secondary individuals and the product, as initiated by the specific calls to action delivered to them as a result of their scanning of the attached insignia or tapping of the attached NFC/RFID tag.

1. A system for facilitating commercial interactions using a physical insignia, comprising:
at least one physical insignia adapted to be integrated to a commercial offering;
a processor, memory and computer software, written on non-transient computer readable media and containing instructions stored in memory and executable by the processor to:
receive an indication that a first computing device has invoked the insignia;
receive an indication that a second computing device has invoked the insignia; and
present at least one option to a commercial entity for communicating with the first or second computing device in connection with the insignia via a purchase and service management component.

2. The system of claim 1 wherein the at least one option is a sales offer provided via an offer management component.

3. The system of claim 1 further including instructions executable by the processor to register ownership of the commercial offering associated with the insignia via a registration component.

4. The system of claim 3 further including instructions executable by the processor to reward the registered owner for commercial transaction referrals via a referral management component.

5. The system of claim 1 further including instructions executable by the processor for soliciting and recording customer feedback about the commercial offering via a customer feedback component.

6. A system for facilitating commercial interactions using a physical insignia, comprising:
a processor, memory and computer software, written on non-transient computer readable media and containing instructions stored in memory and executable by the processor to:
receive an indication that a first computing device has invoked at least one physical insignia integrated with a commercial offering;
register ownership of the commercial offering via a registration component;
present at least one option to a commercial entity for communicating with an owner registered in connection with the insignia via a purchase and service management component;
receive an indication that a second computing device has invoked the insignia via an interaction tracking component;
present a sales offer to the second computing device via an offer management component; and
reward the registered owner for commercial transaction referrals via a referral management component.

7. The system of claim 6 further including instructions executable by the processor for soliciting and recording customer feedback about the commercial offering via a customer feedback component.

8. A method for facilitating commercial interactions using a physical insignia, comprising:
integrating at least one physical insignia into a commercial offering;
detecting, via a computer system, that a first computing device has invoked the insignia;
presenting at least one option to a commercial entity for communicating with the first computing device that invoked the insignia;
receiving an indication that a second computing device has invoked the insignia; and
rewarding an owner associated with the commercial offering as a result of the received indication.

9. The method of claim 8, further comprising:
receiving a request from the second computing device to purchase the commercial offering or for additional product information.

10. The method of claim 8, further comprising:
providing time-based or location-based information to the second computing device.

11. The method of claim 8, further comprising:
soliciting and recording customer feedback about the commercial offering.

12. The method of claim 8, wherein the first and second computing devices are mobile computing devices, each having a respective display, and further including the step of presenting a sales offer to the second computing device, wherein the sales offer is displayed on the second computing device display.
